(19) United States
(12) Patent Application Publication
(10) Pub. No.: US 2012/0047375 A1
(43) Pub. Date: Feb. 23, 2012

(54) INFORMATION PROCESSING APPARATUS, METHOD OF CONTROLLING THE SAME, AND STORAGE MEDIUM

(75) Inventor: Minoru Hashimoto, Chigasaki-shi (JP)

(73) Assignee: CANON KABUSHIKI KAISHA, Tokyo (JP)

(21) Appl. No.: 13/209,635

(22) Filed: Aug. 15, 2011

(30) Foreign Application Priority Data
Aug. 23, 2010 (JP) 2010-186189

(51) Int. Cl. G06F 1/26

(52) U.S. Cl. 713/300

(57) ABSTRACT

An apparatus includes a storage unit, a power source unit configured to supply power in a normal operation mode, a power supply unit configured to receive power from an external apparatus, a communication unit configured to communicate with the external apparatus, a control unit configured to rewrite the storage unit using data received from the communication unit, and a switching unit configured to switch power supply to the storage unit between from the power source unit and from the power supply unit, wherein the control unit controls the switching unit, when receiving a rewrite request command from the external apparatus, to supply power to the storage unit from the external power supply unit, so that rewriting of the storage unit is executed.

### BACKGROUND OF THE INVENTION

1. Field of the Invention

The present invention relates to an information processing apparatus, a method of controlling the same, and a storage medium. More specifically, the present invention relates to an information processing apparatus, including a memory therein, and a method of controlling the same.

2. Description of the Related Art

Conventional information processing apparatuses such as multifunction peripheral (MFP) for office use each have a nonvolatile memory therein in which programs and data are stored. The programs and data are rewritten (hereinafter, also referred to as “rewriting of memory”) in the following procedure:

(1) an administrator starts up a target apparatus using commercial power supply
(2) data is transmitted from an external device to the apparatus to rewrite a program stored in the apparatus
(3) the administrator causes the rewritten program to be executed.

In the cases where rewriting of a program stored in a packaged apparatus is required at a service deposit, the work to open the package, assemble the apparatus, connect the apparatus to the commercial power supply, activate the apparatus, rewrite a program, and repack the apparatus requires more than one hour in total. Thus, rewriting of the program is a time-consuming and laborious task to be avoided as much as possible to improve efficiency of work.

On the other hand, in the case of a portable battery-powered apparatus, rewriting of a program with external data and execution of the rewritten program is performed based on battery power without using commercial power supply. Such rewriting of a memory of the battery-powered apparatus, however, has a disadvantage that, if the power source is once turned off during rewriting, the rewriting is interrupted. As a result, the target program cannot be started.

To prevent running out of battery and failure caused thereby in rewriting, Japanese Patent Application Laid-Open No. 2002-176582 discusses a technique to supply external power for rewriting of memory. Japanese Patent Application Laid-Open No. 2000-276347 discusses a technique to supply external power and to directly rewrite data in a nonvolatile memory from an external apparatus.

One approach to supply external power is to utilize universal serial bus (USB) power system in which power is supplied from a personal computer (PC) to an apparatus through a USB cable. The USB cable is composed of a USB communication line and a USB bus power line, which enables communication between a host PC and an MFP and power supply from the host PC to the MFP. Hence, the USB bus power system has been studied for use in rewriting of memory.

The USB bus power system, however, can supply power of only about 2.5 W, which is insufficient for an MFP requiring more than 100 W. The MFP consuming more than 10 W at its main central processing unit (CPU) cannot use USB bus power for driving the main CPU to rewrite the memory. In addition, as described above, the work to provide external commercial power supply to the MFP is already time consuming and laborious.

### SUMMARY OF THE INVENTION

The present invention is directed to a technique capable of supplying power only to a portion requiring power supply of an apparatus that may consume a large amount of power and facilitating rewriting of memory in the apparatus with a small amount of power.

According to another aspect of the present invention, an information processing apparatus includes a storage unit, an internal power source unit configured to supply power in a normal operation mode, an external power supply unit configured to receive power from an external apparatus, a communication unit configured to communicate with the external apparatus, a control unit configured to rewrite the storage unit using data received from the communication unit, and a power source switching unit configured to switch power supply to the storage unit between from the internal power source unit and from the external power supply unit, wherein the control unit controls the power source switching unit, when receiving a rewrite request command from the external apparatus through the communication unit, to supply power to the storage unit from the external power supply unit, so that rewriting of the storage unit is executed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a schematic configuration of an information processing apparatus control system that includes an information processing apparatus according to a first exemplary embodiment of the present invention.

FIG. 2 is a block diagram illustrating a schematic configuration of a main controller unit according to the first exemplary embodiment of the present invention.

FIG. 3 is a block diagram illustrating a schematic configuration of an I/F unit according to the first exemplary embodiment.

FIG. 4 is a flowchart illustrating a memory rewriting processing flow executed in a host PC according to the first exemplary embodiment.

FIG. 5 is a flowchart illustrating a memory rewriting processing flow executed by a sub CPU of an MFP according to the first exemplary embodiment.

FIG. 6 is a block diagram illustrating a schematic configuration of a main controller unit according to a second exemplary embodiment of the present invention.

FIG. 7 is a block diagram illustrating a schematic configuration of an I/F unit according to the second exemplary embodiment.

FIG. 8 is a flowchart illustrating a memory rewriting processing flow executed in a host PC according to the second exemplary embodiment.

FIG. 9 is a flowchart illustrating a memory rewriting processing flow executed by a sub CPU of an MFP according to the second exemplary embodiment.

FIG. 10 is a block diagram illustrating a schematic configuration of a main controller unit according to a third exemplary embodiment of the present invention.

FIG. 11 is a block diagram illustrating a schematic configuration of an I/F unit according to the third exemplary embodiment.

FIG. 12 is a flowchart illustrating a memory rewriting processing flow executed by a sub CPU of an MFP according to a fourth exemplary embodiment of the present invention.

FIG. 13 illustrates a rewriting permission table according to a fifth exemplary embodiment of the present invention.

### DESCRIPTION OF THE EMBODIMENTS

Various exemplary embodiments, features, and aspects of the invention will be described in detail below with reference to the drawings.

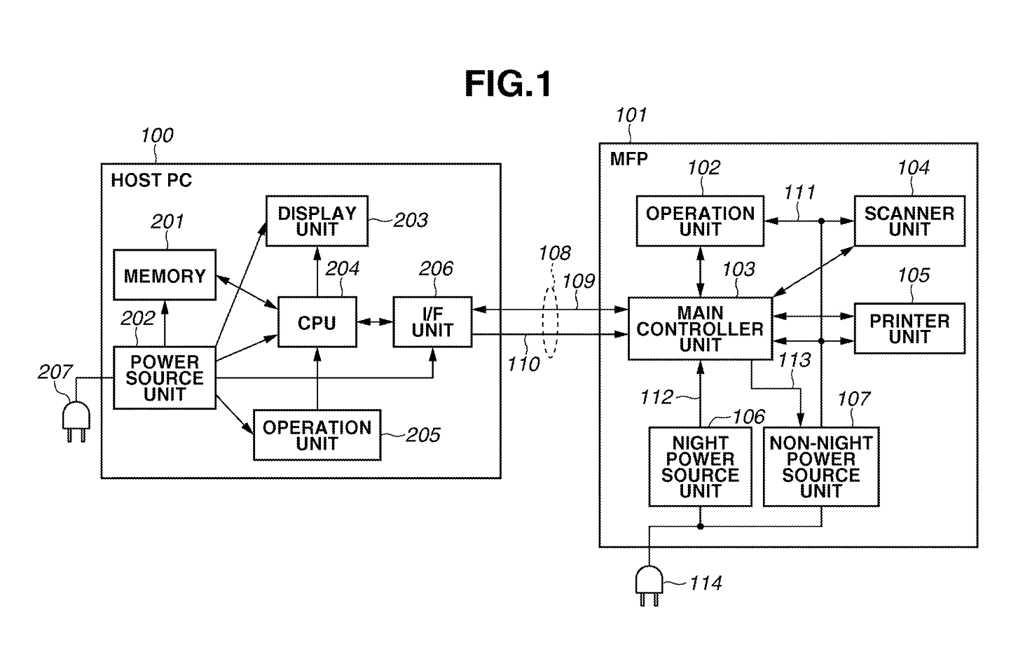

FIG. 1 is a block diagram illustrating a schematic configuration of an information processing apparatus control system that includes an information processing apparatus according to an exemplary embodiment of the present invention.

In FIG. 1, a multifunction peripheral (MFP) 101 is an information processing apparatus having functions for printing, scanning, and copying, for example. The printing function enables transmission of job data from a host PC 100 to the MFP 101, conversion of the job data into image data at the MFP 101, and printing of the image data onto recording paper by a printer unit 105.

The scanning function enables conversion of document data into image data by a scanner unit 104 of the MFP 101, and transmission of the image data to the host PC 100. The copying function enables conversion of document data into image data by a scanner unit 104 of the MFP 101, and printing of the image data by the printer unit 105.

The MFP 101 is connected to the host PC 100 via a USB cable 108. The USB cable 108 is composed of a USB signal line 109 for transmitting signals in USB communication and a USB bus power line 110 USB bus power line 110 for supplying power from the host PC 100 to the MFP 101.

The USB bus power line 110 is capable of supplying power of 2.5 W (5 V, 500 mA) at most. The MFP 101, in operation, does not use the power supplied from the USB bus power line 110.

The MFP 101 includes a main controller unit 103 that controls printing, scanning, and copying by the MFP 101, as follows.

The main controller unit 103 controls operations of the MFP 101, and transmits/receives data, converts data, stores data, and controls power supply of the MFP 101.

When the MFP 101 performs printing, the host PC 100 generates job data which is transferred to the main controller unit 103 via the USB signal line 109, and temporarily stored there. The main controller unit 103 converts the job data stored therein into image data, and transmits the converted data to the printer unit 105. Under control of the main controller unit 103, the printer unit 105 prints the image data onto recording paper, and discharges the paper out of the apparatus.

When the MFP 101 scans data, a user, after setting a document on the scanner unit 104, operates buttons referring to a screen of the operation unit 102 to set scanning conditions, and instructs start of scanning operation.

Under control of the main controller unit 103, the scanner unit 104 optically reads document data, and converts the data into image data. The image data is temporarily stored in main controller unit 103, and is, when needed, converted into another data format by the main controller unit 103 and transferred to a destination designated beforehand by the operation unit 102.

When the MFP 101 performs copying, a user, after setting a document on the scanner unit 104, operates buttons referring to the screen of the operation unit 102 to set copy conditions, and instructs start of copy operation.

Under control of the main controller unit 103, the scanner unit 104 optically reads document data, and converts the data into image data. The image data is temporarily stored in main controller unit 103, and is converted into another data format by the main controller unit 103. The printer unit 105 prints the image data onto recording paper, and discharges the paper out of the apparatus.

Next, power supply method in the MFP 101 will be described below.

The MFP 101 includes two internal power sources: a night power source unit 106 and a non-night power source unit 107. The night power source unit 106 constantly outputs power in a normal operation mode of the MFP 101 in which commercial power supply is supplied through a power source plug 114, and the night power source unit 106 supplies power through a night power source line 112 to only a part of the main controller unit 103.

The main controller unit 103 is provided with a function to control the power of the MFP 101 as described above, and can monitor states of the apparatus and signals input from outside to switch the apparatus between a power-on state and a power saving mode.

When the main controller unit 103 switches the apparatus to the power-on state, the non-night power source unit 107 outputs power. The power is supplied to units throughout the MFP 101 via a non-night power source line 111. For example, the main controller unit 103 consumes power of about 100 W for a high speed processing in data format conversion, whereas consumes power of about 1000 W for an image formation process in printing.

In the power-on state, the main controller unit 103 switches the apparatus into the power saving mode when a user presses a power switch (not illustrated) or a predetermined period of time elapses in an idle state. In the power saving mode, the non-night power source unit 107 does not outputs power, but waits for a turn-on trigger (or start-up factor) of the night power source unit 106.

Examples of the turn-on trigger or start-up factor include an activation using a timer that is set during the power-on state, a pressing of the power switch by a user, and a reception of job data from an external device. In the power saving mode, the night power source unit 106 supplies power to only a part of the main controller unit 103, so that the main controller unit 103 consumes power of about 1 W.

Next, the host PC 100 will be briefly described below.

The host PC 100 is a general information processing apparatus such as a notebook computer, and includes mainly a central processing unit (CPU) 204 that controls the entire host PC 100, and a memory 201 where programs and data are stored. The memory 201 includes volatile and nonvolatile memories.

The host PC 100 further includes an operation unit 205 as an operation input means used by a user to manipulate the host PC 100, and a display unit 203 as display means. The host PC 100 further includes an I/F unit 206 that is connected to and communicates with external devices such as the MFP 101, and a power source unit 202 that receives commercial power supply through a power source plug 207 and supplies stable power to the host PC 100.

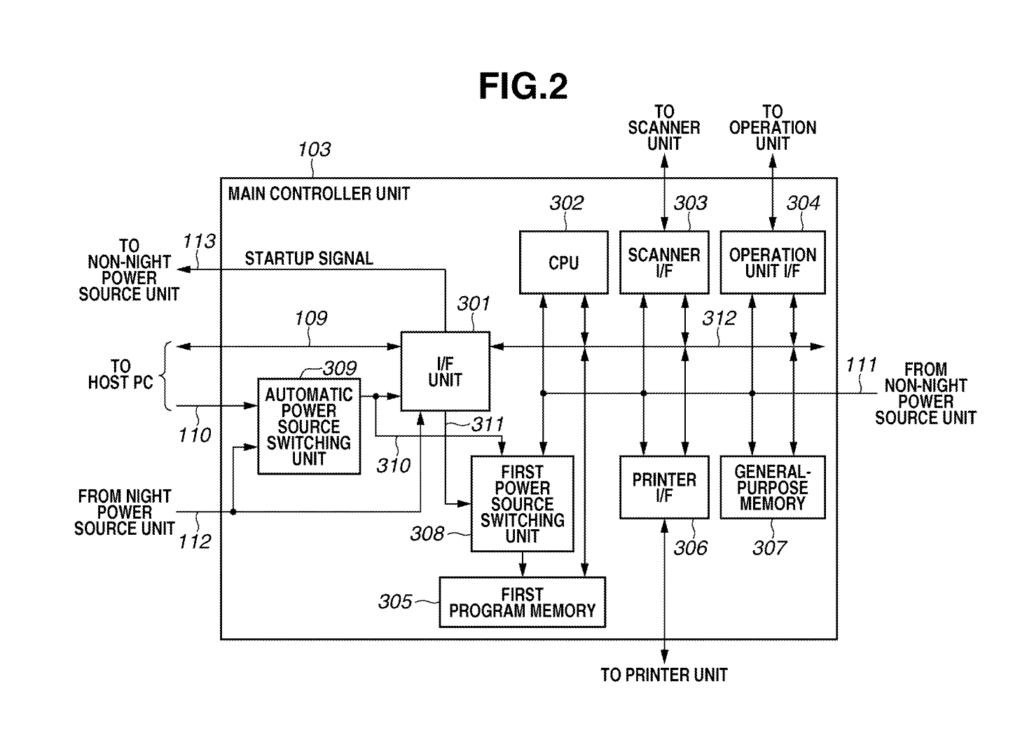

FIG. 2 is a block diagram illustrating a schematic configuration of a main controller unit 103 according to the first exemplary embodiment of the present invention.

In FIG. 2, the CPU 302 reads a program from a first program memory 305 that is a nonvolatile memory, and executes it. In the execution, the CPU 302 uses a general-purpose memory 307 as a temporal storage area. The CPU 302 is connected, via an internal bus 312, to an I/F unit 301 to communicate with external devices such as the host PC 100, a scanner I/F 303 to communicate with the scanner unit 104, and a printer I/F 306 to communicate with the printer unit 105.

The CPU 302, the scanner I/F 303, the operation unit I/F 304, the printer I/F 306, the general-purpose memory 307, and the first power source switching unit 308 each receive power from the non-night power source unit 107 through the non-night power source line 111 while the apparatus is in the power-on state.

In the power saving mode, a part of the I/F unit 301 receives power from the night power source unit 106 through the night power source line 112 to detect the above-described start-up factor. In the power saving mode, when detecting the start-up factor, the I/F unit 301 notifies the non-night power source unit 107 of the start-up by changing a start-up signal 113. The non-night power source unit 107, after being notified of the start-up by the change in the signal 113, starts to output power.

When the MFP 101 is connected to the host PC 100 by the USB cable 108, the I/F unit 301 is connected to the USB signal line 109. The USB signal line 109 enables transmission/reception of data, reception of commands, and status response to the commands between the MFP 101 and the host PC 100.

Even in the power saving mode, the I/F unit 301 can communicate with the host PC 100 based on the power supply from the night power source unit 106. The I/F unit 301 returns status response to commands, without using the CPU 302 of the main controller unit 103, when the I/F unit 301 can handle the commands by itself. Thus, the time period of the power saving mode can be maintained longer, resulting in saving of power consumption.

To enable status response from the I/F unit 301, the CPU 302 sends status information to the I/F unit 301 to store therein, prior to switching from the power-on state to the power saving mode. During the power saving mode, when receiving a command or job data the I/F unit 301 cannot handle, the I/F unit 301 changes the start-up signal 113, which switches the power saving mode to power-on state, so that the command is processed by the CPU 302.

An automatic power source switching unit 309 is configured to automatically switch between the power supply from the night power source unit 106 through the night power source line 112 and the power supply from the host PC 100 through the USB bus power line 110. The automatic power source switching unit 309, as external power supply means, supplies power to the I/F unit 301 through the power source line 310 after the switching.

The power is supplied from the night power source unit 106 during in the power saving mode and the power-on state, and the power supply from the USB bus power line 110 is executed when rewriting the first program memory 305.

The first power source switching unit 308 is configured to switch the power supply to the first program memory 305 between from the non-night power source unit 107 and from the USB bus power line 110 through the power source line 310, based on control of the I/F unit 301. In other words, the first power source switching unit 308 receives power from the non-night power source unit 107 during the power-on state, and from the USB bus power line 110 through the power source line 310 when rewriting the first program memory 305.

The I/F unit 301 outputs a first power source switch signal 311 to the first power source switching unit 308, which switches the power supply to the first program memory 305.

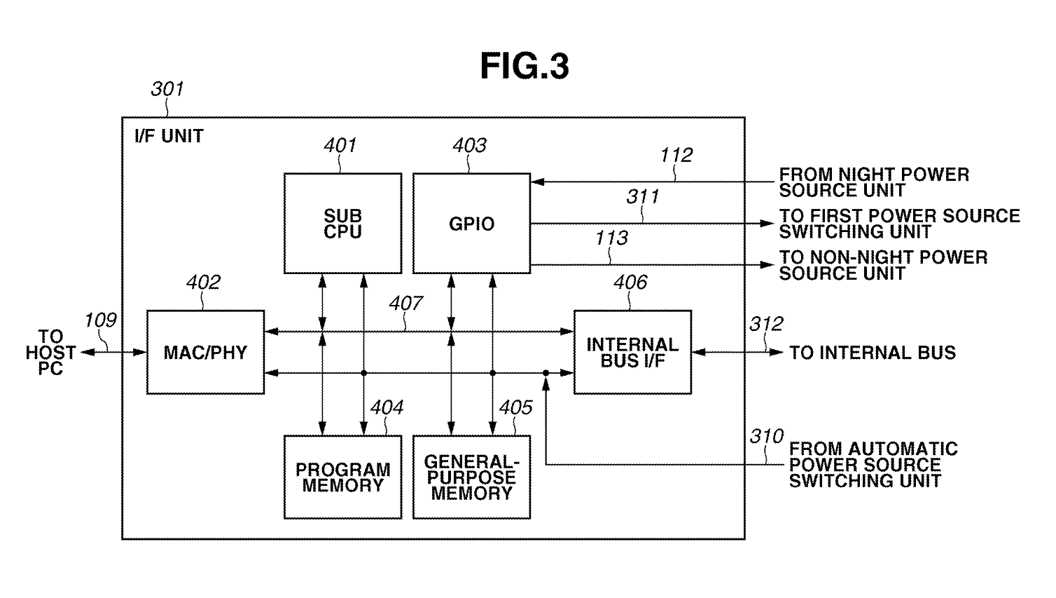

FIG. 3 is a block diagram illustrating a schematic configuration of the I/F unit 301 according to the first exemplary embodiment.

A sub CPU 401 performs processing to be executed by the I/F unit 301. The sub CPU 401 reads programs from a program memory 404 that is a nonvolatile memory, and executes them. In the execution, the sub CPU 401 uses a general-purpose memory 405 as a temporal storage area.

A media access control (MAC)/physical layer (PHY) 402 changes formats of signals from the USB signal line 109 and signals from internal bus 407 individually. A general purpose input/output (GPIO) 403 is an interface to control input signals for detecting the state of the MFP 101 and output signals for controlling the MFP 101.

The input signals to the GPIO 403 include signals from the night power source line 112 that detect a start-up factor of the night power source unit 106. The output signals to the GPIO 403 include the start-up signal 113 for controlling off/on states of the non-night power source unit 107, and the first power source switch signal 311 for controlling switches at the first power source switching unit 308. Input/output of these signals are controlled by the sub CPU 401.

An internal bus I/F 406 is an interface to connect the internal bus 312 of the main controller unit 103 to an internal bus 407 of the I/F unit 301. This allows transmission/reception of data and commands between the sub CPU 401 and the CPU 302.

The above-described sub CPU 401, MAC/PHY 402, GPIO 403, program memory 404, general-purpose memory 405, and internal bus I/F 406 each receive power from the automatic power source switching unit 309 through the power source line 310.

While the MFP 101 is in the power-on state, the CPU 302 can directly control the MAC/PHY 402 and the general-purpose memory 405 in the I/F unit 301, but the sub CPU 401 stops its operations.

The CPU 302 writes information about the state of the MFP 101 into the general-purpose memory 405 before the MFP 101 enters the power saving mode from the power-on state, and then notifies the sub CPU 401 of the shift of the MFP 101 to the power saving mode. When the sub CPU 401 controls the GPIO 403 to put the start-up signal 113 into an off-state, so that the non-night power source unit 107 stops outputting of power.

While the MFP 101 is in the power saving mode, the I/F unit 301 is not supplying power to the CPU 302, and hence the sub CPU 401 controls the MAC/PHY 402 to enable communication with the host PC 100. In this way, during the power saving mode, communication between the MFP 101 and the host PC 100 is enabled under control by the sub CPU 401.

In the present exemplary embodiment, the USB system is used for connection and communication between the MFP 101 and the host PC 100, but it is not limited thereto, and other system may be used. For example, the MFP 101 may be connected to the host PC 100 through a network such as Ethernet, and communicate using a known protocol.

A memory rewriting processing will be described, in which the host PC 100 supplies power to the main controller unit 103 in the MFP 101 through a USB bus power line to rewrite the first program memory 305.

The following description is based on the assumption that the MFP 101 is disconnected from commercial power supply. This is because, if the MFP 101 receives commercial power supply, rewriting of the first program memory 305 can be executed through communication between the CPU 302 and the host PC 100 through the I/F unit 301.

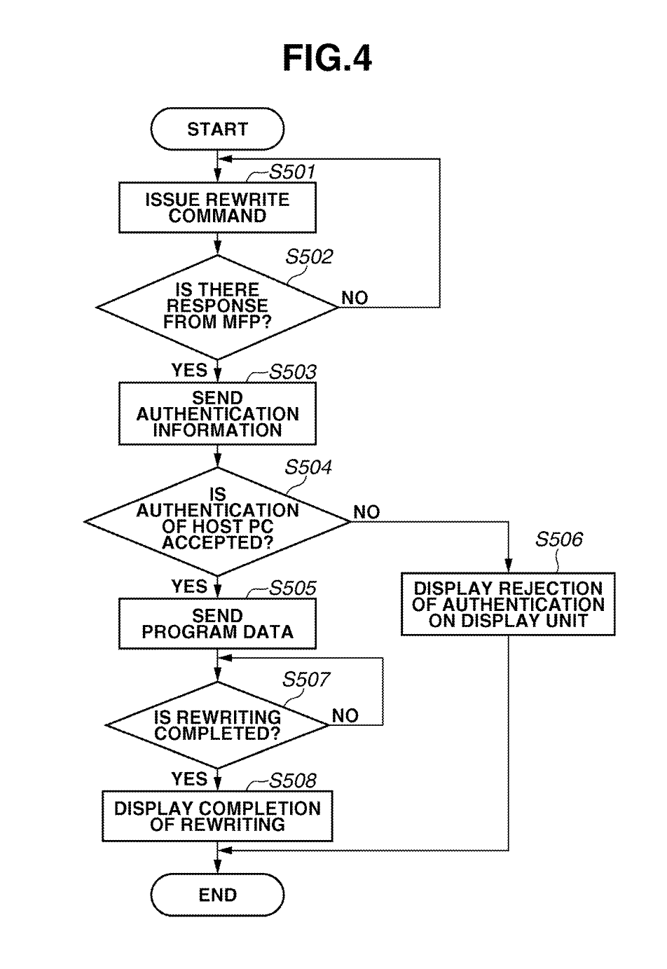

FIG. 4 is a flowchart illustrating a memory rewriting process executed in a host PC 100 according to the first exemplary embodiment.

In step S501, when a user operates the operation unit 205, the host PC 100 (i.e., the CPU 204 therein) issues a rewrite request command to the MFP 101. In step S502, when it is determined that there is a response from the MFP 101 in response to the command (YES in step S502), in step S503, the CPU 204 of the host PC 100 sends authentication information to the MFP 101.

Examples of the authentication information include a password, an ID number representing the first program memory 305 to be rewritten, a version number of program data for the first program memory 305, and a size of the program data.

In step S504, when it is determined that the authentication of the MFP 101 is accepted (YES in step S504), in step S505, the CPU 204 of the host PC 100 sends program data for rewriting to the MFP 101. On the other hand, in step S504, when it is determined that the response from the MFP 101 is rejected (NO in step S504), in step S506, the CPU 204 of the host PC 100 displays a message indicating the rejection of the authentication on the display unit 203. Then, the processing ends.

In step S507, the CPU 204 of the host PC 100 waits for completion of rewriting the first program memory 305 by the MFP 101. When the rewriting is completed (YES in step S507), in step S508, the CPU 204 of the host PC 100 displays a message indicating the completion of the rewriting on the display unit 203. Then, the processing ends.

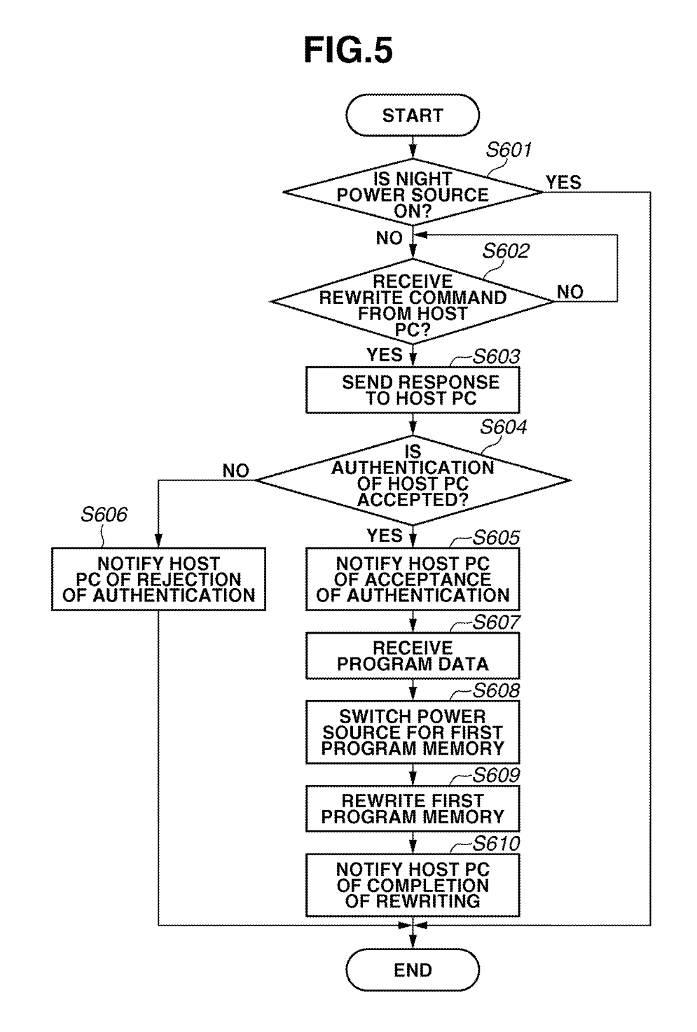

FIG. 5 is a flowchart illustrating a memory rewriting processing executed by the sub CPU 401 of the MFP 101 according to the first exemplary embodiment. As described above, the following description is based on the assumption that the MFP 101 is disconnected from commercial power supply, and power is supplied to the I/F unit 301 in the MFP 101 through the USB bus power line 110 from the host PC 100.

In step S601, the sub CPU 401 accesses the GPIO 403 to examine the voltage of the night power source line 112, and determines whether the night power source unit 106 is in the power-on state. In other words, the sub CPU 401, when the voltage of the night power source line 112 is 0 V, determines that the MFP 101 is disconnected from commercial power supply and is supplied with power from the host PC 100 through the USB bus power line 110.

The sub CPU 401 confirms the disconnection of commercial power supply to determine that the CPU 302 is not in operation and that the first program memory 305 is not in use.

In step S601, when it is determined that the night power source unit 106 is in the power-on state (YES in step S601), the processing ends. When it is determined that the night power source unit 106 is not in the power-on state (NO in step S601), in step S602, the sub CPU 401 determines whether the sub CPU 401 has received a rewrite request command from the host PC 100. When the sub CPU 401 determines that the sub CPU 401 has received the command (YES in step S602), in step S603, the sub CPU 401 sends a response to the host PC 100.

In step S604, the sub CPU 401 verifies authentication based on the authentication information received from the host PC 100. More specifically, the sub CPU 401 determines whether the password, the ID number of the first program memory 305 to be rewritten, the version number of program data, and the size of the program data, which are received from the host PC 100, are appropriate or not.

The verification is performed by the sub CPU 401 by referring to the information stored in advance in the program memory 404.

In step S604, when the sub CPU 401 determines that the authentication is accepted (YES in step S604), in step S605, the sub CPU 401 notifies the host PC 100 of the acceptance, and the processing proceeds to step S607. In step S604, when the sub CPU 401 determines that the authentication is rejected (NO in step S604), in step S606, the sub CPU 401 notifies the host PC 100 of the rejection, which ends the process.

In step S607, the sub CPU 401 receives program data from the host PC 100, and stores the data in the general-purpose memory 405.

In step S608, the sub CPU 401 accesses the GPIO 403, and switches the first power source switching unit 308 based on the first power source switch signal 311, to supply power to the first program memory 305 through the USB bus power line 110.

In step S609, the sub CPU 401 rewrites the first program memory 305. After completion of the rewriting, in step S610, the sub CPU 401 notifies the host PC 100 of the completion, which ends the processing.

As described above, even when no commercial power supply is not provided, program data can be received under control of the sub CPU 401 with power supply such as USB bus power supply from the host PC 100, and power supply is switched to the first program memory 305, so that rewriting of the memory can be achieved. This configuration enables power supply only to a portion requiring power supply of an apparatus that may consume a large amount of power and to facilitate rewriting of a memory in the apparatus with a small amount of power.

Next, a second exemplary embodiment of the present invention is described. The second exemplary embodiment has a configuration similar to that illustrated in FIG. 1, which will not be described.

In the second exemplary embodiment of the present invention, a CPU 302 uses two nonvolatile memories, and serially switches power supply to the memories to rewrite the memories.

Examples of the two nonvolatile memories include a flash read only memory (ROM) and a hard disk drive (HDD). The flash ROM is suitable for use in high-speed and small-volume application to be accessed at beginning of startup. The HDD having large capacity but low rate access is suitable for storing operating system (OS) and applications.

The HDD incorporates a motor therein, and generally consumes a large amount of electric current. In the present exemplary embodiment, only an electric current of up to 2.5 W can be provided to the HDD, and thereby a 1.8-inch HDD operable with electric current of 2 W or less is used. The power supply capability through USB of the host PC 100 depends on the type of the host PC 100. Thus, on the assumption of the case with no margin in power supply, power consumption in rewriting should be as low as possible. Accordingly, the flash ROM and the HDD receive power supply, not simultaneously but serially.

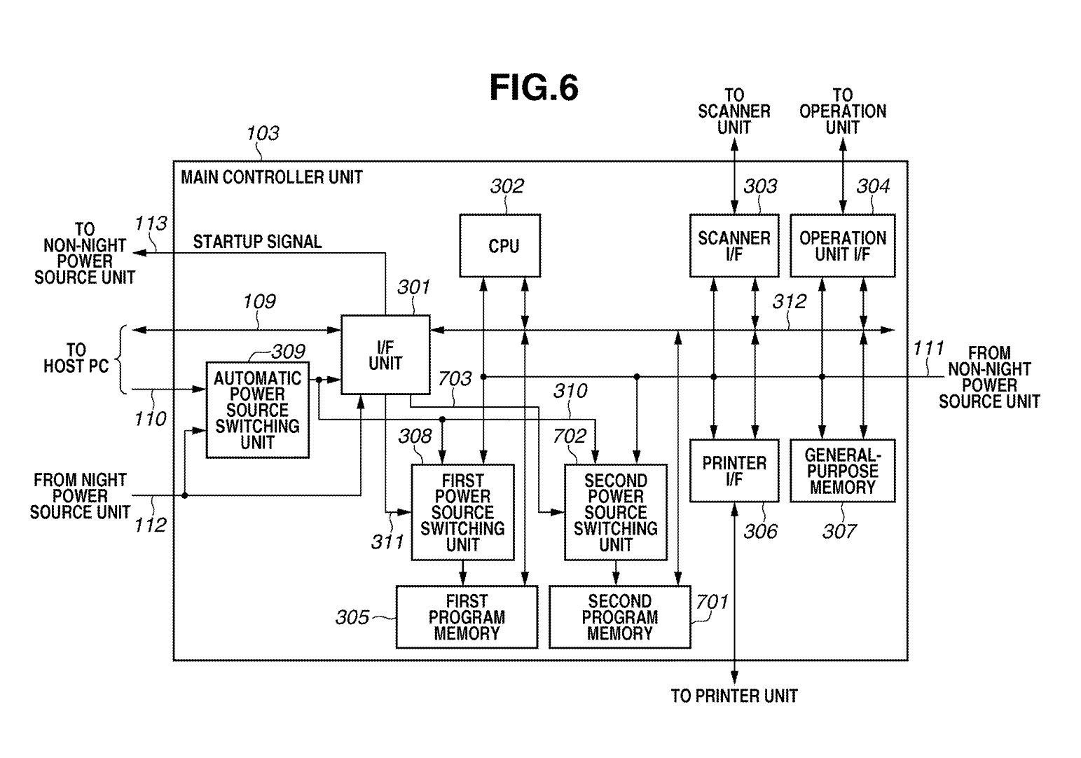

FIG. 6 is a block diagram illustrating a schematic configuration of a main controller unit 103 according to the second exemplary embodiment of the present invention.

The main controller unit 103 in FIG. 6 differs from the main controller unit 103 illustrated in FIG. 2 of the first exemplary embodiment, in that the main controller unit 103 in FIG. 6 further includes a second program memory 701, a second power source switching unit 702, and a second power source switch signal 703.

The other components of the main controller unit 103 are similar to those of the main controller unit 103 in FIG. 2, which are designated by the same reference numerals and will not be described.

The second program memory 701 is a nonvolatile memory and connected to the internal bus 312, as is the first program memory.

The second power source switching unit 702 is configured to switch power supply to the second program memory 701 between from non-night power source unit 107 and from the USB bus power line 110 through the power source line 310 under control of the I/F unit 301.

In other words, the second power source switching unit 702 supplies power from the non-night power source unit 107 through the non-night power source line 111 during the power-on state, and supplies power from the USB bus power line 110 through the power source line 310 to rewrite the second program memory 701.

The above switching of power supply to the second program memory 701 is executed based on a second power source switch signal 703 output from the I/F unit 301 to the second power source switching unit 702.

The sub CPU 401 is capable of controlling the first power source switch signal 311 and the second power source switch signal 703 individually, which enables control of power supply in such a manner that power is supplied only to the first program memory 305 first, and then to the second program memory 701, for example.

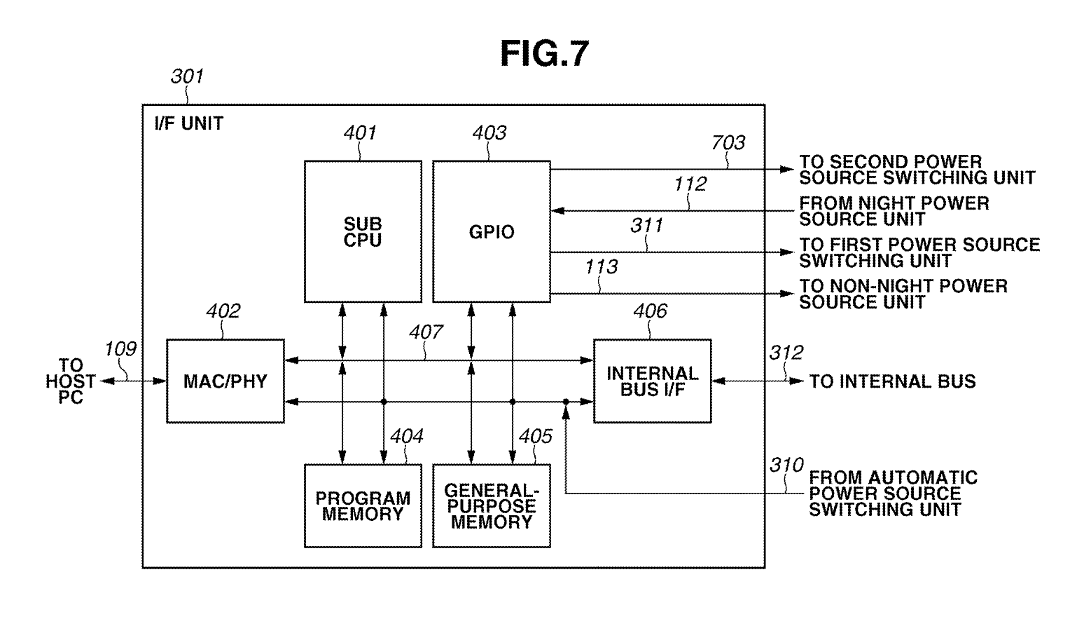

FIG. 7 is a block diagram illustrating a schematic configuration of the I/F unit 301 according to the second exemplary embodiment.

The I/F unit 301 in FIG. 7 differs from the I/F unit 301 in FIG. 3 in the first exemplary embodiment, in that the I/F unit 301 in FIG. 7 further includes an output port at the GPIO 403, and that the sub CPU 401 can control the second power source switch signal 703. The other parts of the I/F unit 301 in FIG. 7 are identical to those in the first exemplary embodiment, which are designated by the same reference numerals and will not be described.

Input signals to GPIO 403 include a signal input from the night power source line 112 that is used to detect start-up factor of the night power source unit 106. The GPIO 403 outputs signals including a startup signal 113 to control power off/on state of the non-night power source unit 107, a first power source switch signal 311 for switching at the first power source switching unit 308, and a second power source switch signal 703 for switching at the second power source switching unit 702. Input/output of these signals are controlled by the sub CPU 401.

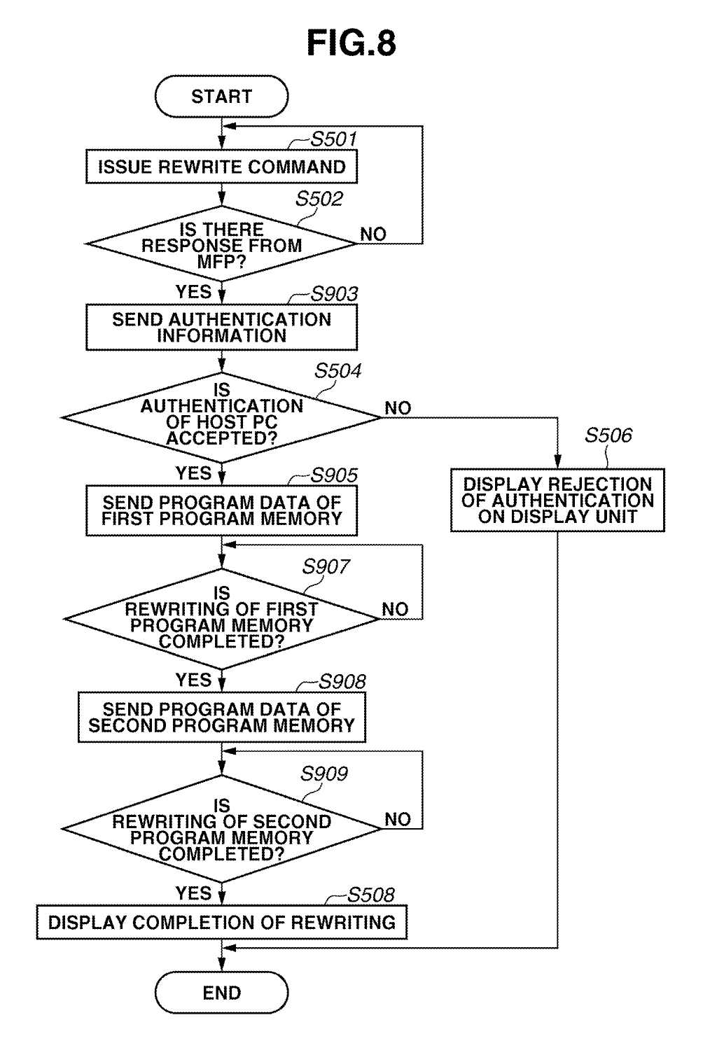

FIG. 8 is a flowchart illustrating a flow of memory rewriting processing executed in the host PC 100 according to the second exemplary embodiment.

The flowchart in FIG. 8 differs from that in FIG. 4 described in the first exemplary embodiment, in that, in step S903, the CPU 204 of the host PC 100 sends authentication information further including information about the second program memory 701 to the MFP 101.

More specifically, the authentication information further includes an ID number representing the second program memory 701 to be rewritten, a version number of the program data for the second program memory, and the size of the program data. The authentication information to be sent also includes a password, an ID number representing the first program memory 305 to be rewritten, a version number of the program data for the first program memory, and the size of the program data.

The present exemplary embodiment differs from the first exemplary embodiment in that processing for the first program memory 305 and processing for the second program memory 701 are performed individually and serially.

More specifically, in step S905, the CPU 204 of the host PC 100, first, sends program data for rewriting the first program memory 305 to the MFP 101, and then, in step S907, waits for completion of the rewriting of the first program memory 305 at the MFP 101.

In step S908, the CPU 204 of the host PC 100 sends program data for rewriting the second program memory 701 to the MFP 101, and, in step S909, waits for completion of the rewriting. The processing then proceeds to step S508.

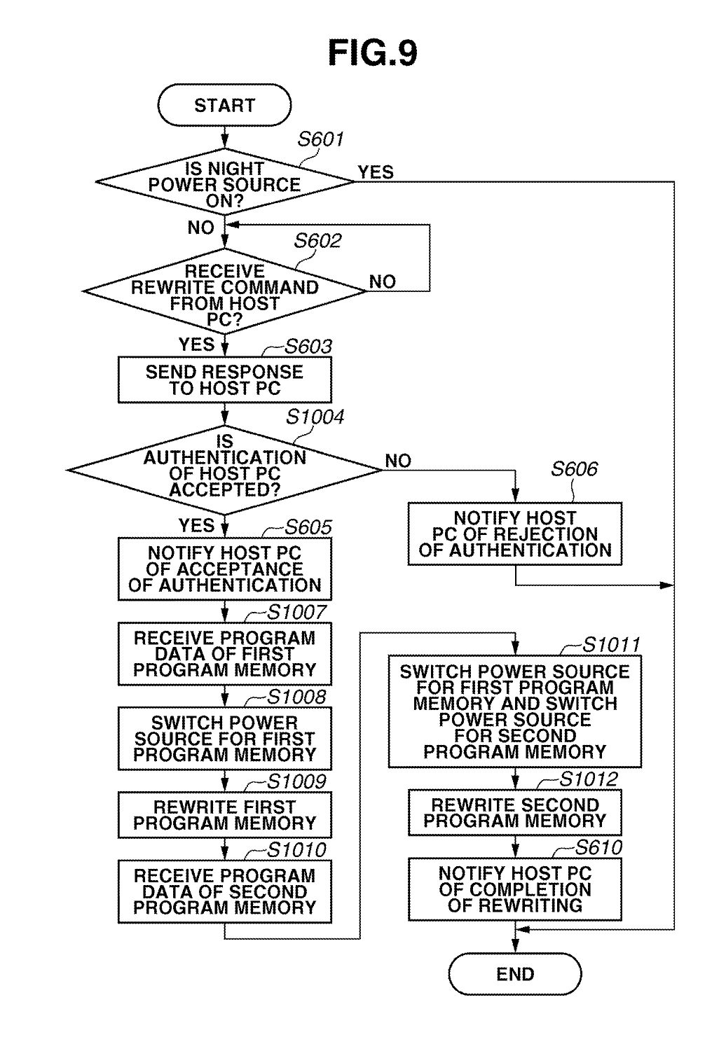

FIG. 9 is a flowchart illustrating a flow of memory rewriting processing executed by the sub CPU 401 of the MFP 101 according to the second exemplary embodiment.

The flowchart in FIG. 9 differs from that in FIG. 5 described in the first exemplary embodiment, in that, in step S1004, the sub CPU 401 verifies the authentication, based on authentication information including information about the first program memory 305 and information about the second program memory 701 received from the host PC 100.

More specifically, the sub CPU 401 determines whether the password received from the host PC 100, the ID number of the first program memory 305, the version number of the program data, and the size of the program data are appropriate or not.

Furthermore, the sub CPU 401 determines whether the password received from the host PC 100, the ID number of the second program memory 701, the version number of the program data, and the size of the program data are appropriate or not.

These determinations are performed by the sub CPU 401 referring to the information stored in advance in the program memory 404.

In the present exemplary embodiment, one of the memory authentications is rejected, the entire authentications are rejected. However, the system may be configured so that, even if one of the memory authentications is rejected, rewriting of the other program memory of accepted authentication is executed.

The present exemplary embodiment differs from the first exemplary embodiment in that the processing for the first program memory 305 and the processing for the second program memory 701 are performed individually and serially.

More specifically, in step S1007, the sub CPU 401 receives program data of the first program memory from the host PC 100, and stores the program data in the general-purpose memory 405.

In step S1008, the sub CPU 401 accesses the GPIO 403, and switches the state of the first power source switching unit 308 based on the first power source switch signal 311, so that power is supplied to the first program memory 305 through the USB bus power line 110. In step S1009, the sub CPU 401 rewrites the first program memory 305.

In step S1010, the sub CPU 401 receives program data of the second program memory 701 from the host PC 100, and stores the program data in the general-purpose memory 405.

In step S1011, the sub CPU 401 accesses the GPIO 403, and switches the state of the second power source switching unit 702 based on the second power source switch signal 703, so that power is supplied to the second program memory 701 through the USB bus power line 110. In step S1012, the sub CPU 401 rewrites the second program memory 701.

In the present exemplary embodiment, in step S1008, the power source for the first program memory 305 is switched to put the first program memory 305 into the power-supplied state, whereas the power source for the second program memory 701 is not switched to put the second program memory 701 into the no power-supplied state.

After completion of rewriting the first program memory 305, in step S1011, the power supply to the first program memory 305 is cut to put the first program memory 305 in the no power-supplied state, whereas the power source is switched to the second program memory 701 to put the second program memory 701 into the power-supplied state.

The above configuration is effective to avoid reduction in margin of power supply capability of the USB due to increased power consumption that is caused by simultaneous power supply to both of the first program memory 305 and the second program memory 701.

As described above, according to the present exemplary embodiment, even when rewriting of a plurality of memories is required, the memories are individually and serially rewritten. Thus, when one of the memories is rewritten, power is not supplied to other memories that are not to be rewritten, thereby reducing power consumption.

A third exemplary embodiment of the present invention will be described. The third exemplary embodiment has a configuration similar to that illustrated in FIG. 1, which will not be described.

In the main controller unit 103 in the first exemplary embodiment, as illustrate in FIG. 2, power is also consumed at the portion that is not related to the rewriting of memory, through internal bus 312 from the I/F unit 301.

More specifically, the power is also supplied to the portion such as the CPU 302 and the general-purpose memory 307 that share the internal bus 312 when the I/F unit 301 communicates with the first program memory 305 through the internal bus 312,

Accordingly, in the third exemplary embodiment of the present invention, the input/output bus connected to the first program memory 305 and the I/F unit 301 is configured to be separated from the other units when rewriting the first program memory 305.

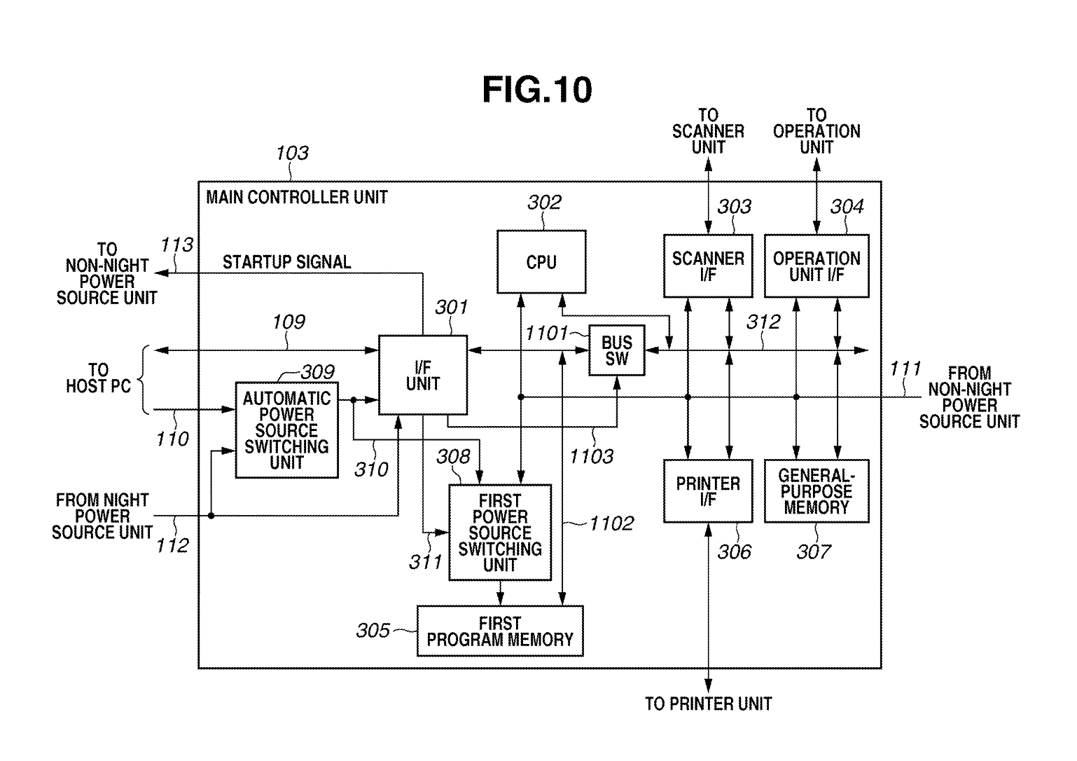

FIG. 10 is a block diagram illustrating a schematic configuration of the main controller unit 103 according to the third exemplary embodiment of the present invention.

The main controller unit 103 illustrated in FIG. 10 differs from the main controller unit 103 in FIG. 2 described in the first exemplary embodiment in that the main controller unit 103 in FIG. 10 further includes a bus switch 1101 that electrically separates the I/F unit 301 and the first program memory 305 from the internal bus 312.

The main controller unit 103 is further configured so that a bus-switch switching signal 1103 for controlling the bus switch 1101 that functions as bus switching means is input from the I/F unit 301 to a bus switch 1101. The main controller unit 103 further includes a local bus 1102 that is connected to the I/F unit 301 and the first program memory 305 and is separated by the bus switch 1101.

The other parts of the main controller unit 103 in FIG. 10 are similar to those of the main controller unit 103 in FIG. 2 described in the first exemplary embodiment, which are designated by the same reference numerals and will not be described.

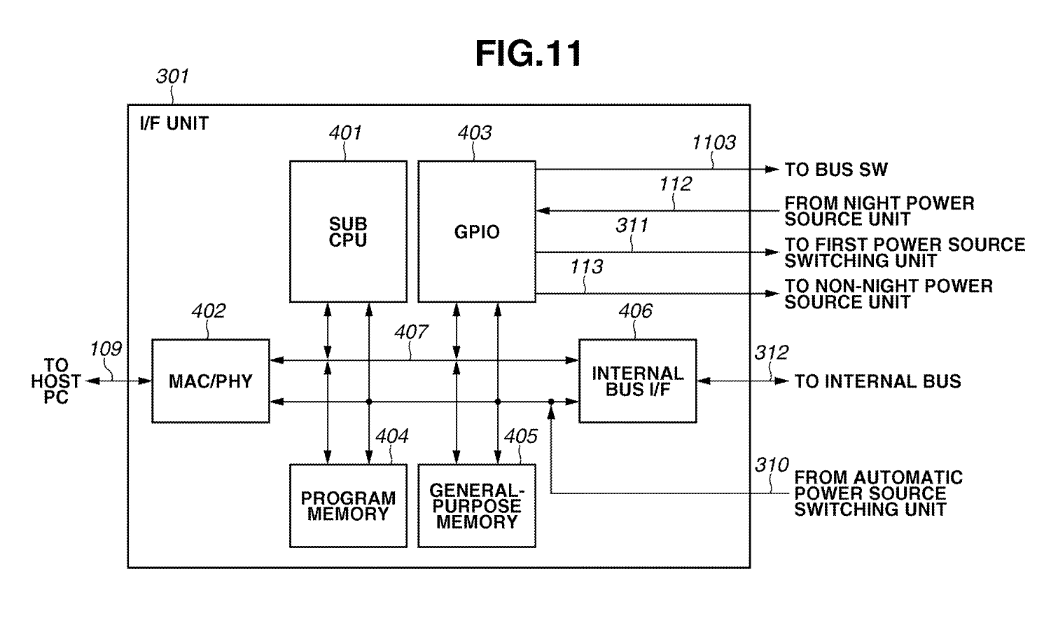

FIG. 11 is a block diagram illustrating a schematic configuration of the I/F unit 301 according to the third exemplary embodiment.

The I/F unit 301 illustrated in FIG. 11 differs from the I/F unit 301 in FIG. 3 described in the first exemplary embodiment in that the I/F unit 301 in FIG. 11 further includes an output port being added to the GPIO 403, and that the GPIO 403 can control the bus-switch switching signal 1103.

The other parts of the I/F unit 301 in FIG. 11 are similar to those of the I/F unit 301 in FIG. 3 described in the first exemplary embodiment, which are designated by the same reference numerals and will not be described.

The output signals to the GPIO 403 further includes a bus-switch switching signal 1103. As a result, at rewriting of the first program memory 305, the sub CPU 401 switches the first power source switching unit 308 based on the first power source switch signal 311, and switches the bus switch 1101 based on the bus-switch switching signal 1103. This processing corresponds to step S608 in FIG. 5.

The memory rewriting processing flow at host PC 100 in the present exemplary embodiment is similar to that described with reference to FIG. 4, which will not be described. The memory rewriting processing flow using the sub CPU 401 of the MFP 101 in the present exemplary embodiment is similar to that described with reference to FIG. 5 except the above-described processing in step S608, which will not be described.

As described above, according to the present exemplary embodiment, a bus switch is provided to reduce flow of electric current through an internal bus to a portion that does not need the current. Switching of the bus switch leads further reduction in power consumption.

In the present exemplary embodiment, the bus switch is applied to the first exemplary embodiment, but obviously can be applied to the second exemplary embodiment.

Next, a fourth exemplary embodiment of the present invention will be described. The fourth exemplary embodiment has configurations similar to those illustrated in FIGS. 1 to 3, which will not be described.

The fourth exemplary embodiment is configured to perform a test prior to rewriting of a program memory, so that the rewriting does not fail due to power shortage during the rewriting.

Failure in rewriting causes the startup of the MFP 101 to fail, which arises a need of a test prior to the rewriting. This is especially effective to the rewriting of a program memory having no margin in power supply of 2.5 W that is power possible to be provided through USB bus power such as a 2.5-inch HDD.

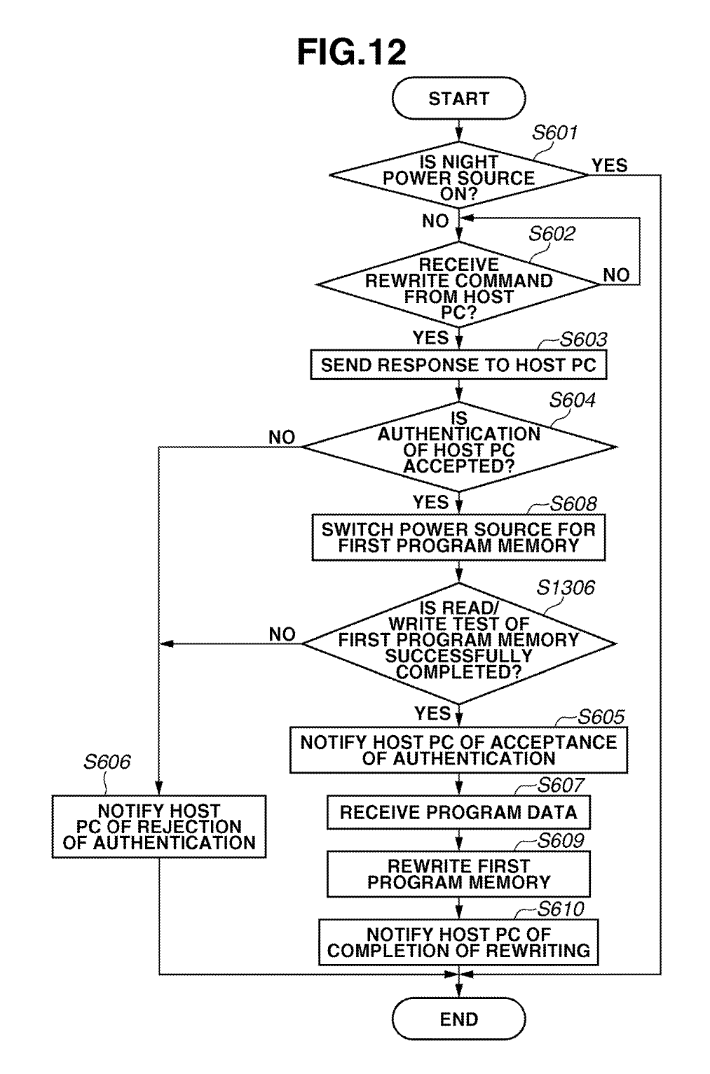

FIG. 12 is a flowchart illustrating a memory rewriting processing executed by the sub CPU 401 of the MFP 101 according to the fourth exemplary embodiment of the present invention.

The flowchart illustrated in FIG. 12 differs from that in FIG. 5 described in the first exemplary embodiment in that, in step S604 when the authentication is accepted, in step S608, the sub CPU 401 switches the first power source switching unit 308 based on the first power source switch signal 311 to supply power to the first program memory 305.

In step S1306, the sub CPU 401 performs a read/write test of the first program memory 305. When no error has occurred (YES in step S1306), the processing proceeds to step S607, and performs rewriting processing in step S607 and subsequent steps. When an error has occurred (NO in step S1306), the processing proceeds to step S606. In step S606, the sub CPU 401 notifies the host PC 100 of rejection of authentication. Then, the processing ends.

As described above, according to the present exemplary embodiment, a read/write test of a program memory to be rewritten is performed prior to rewriting, which prevents in advance any failure of rewriting due to power shortage during the rewriting.

In the present exemplary embodiment, the read/write test is applied to the first exemplary embodiment, but obviously can be applied to the second and the third exemplary embodiments.

Next, a fifth exemplary embodiment of the present invention will be described. The fifth exemplary embodiment has configurations similar to those illustrated in FIGS. 1 to 3, which will not be described.

In the fifth exemplary embodiment, rewriting is not permitted in the case where shortage of power supply using USB bus power system may occur or the case where rewriting may fail due to little margin in power supply.

More specifically, a rewriting permission table (rewriting permission information) is stored in the program memory 404 of the I/F unit 301. The table includes information that indicates whether each of the rewritable program memories stored in the MFP 101 can be rewritten only by the power supplied through USB bus power.

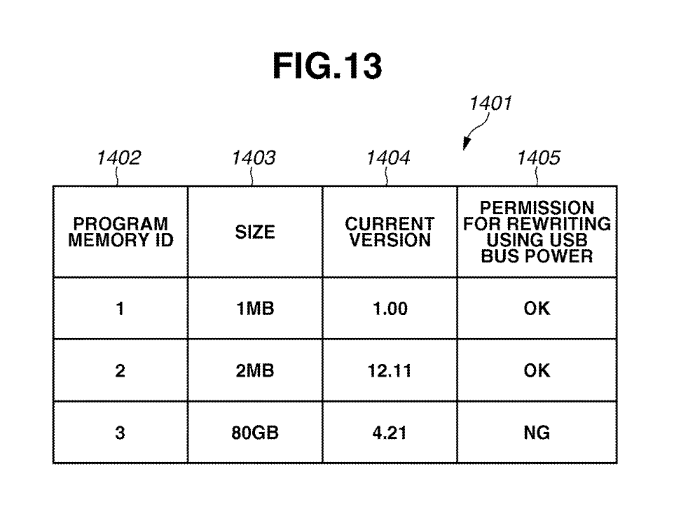

FIG. 13 illustrates a rewriting permission table according to a fifth exemplary embodiment of the present invention.

A rewriting permission table 1401 includes a program memory ID field 1402 for ID numbers to identify program memories as a target for rewriting. The ID number information is included in the authentication information sent from the MFP 101 to the host PC 100, so that the MFP 101 can receive information about a target program memory for rewriting.

The rewriting permission table 1401 includes a size field 1403 for sizes of program memories. The size information is included in the authentication information sent from the MFP 101 to the host PC 100, so that transmission of program data of mismatched size can be prevented.

The rewriting permission table 1401 further includes a version field 1404 for a current version of a program memory. The current version information is included in the authentication information sent from the MFP 101 to the host PC 100, so that rewriting of a memory according to the old version can be prevented. The rewriting permission table 1401 further includes a rewriting permission field 1405 for permission/rejection for rewriting of a memory by power supplied through USB bus power.

The memory rewriting processing in the present exemplary embodiment differs from the processing, which is executed by the sub CPU 401, in FIG. 5 described in the first exemplary embodiment in the operation for authentication based on the authentication information received from the host PC 100.

More specifically, in step S604 in FIG. 5, the sub CPU 401 determines whether to allow rewriting of a target program memory, based on the ID information of the memory received from the host PC 100 and the rewriting permission table 1401 read from the memory. When it is determined that the rewriting is allowed (YES in step S604), in step S605, the sub CPU 401 notifies the host PC 100 of acceptance of authentication. When it is determined that the rewriting is not allowed (NO in step S604), in step S606, the sub CPU 401 notifies the host PC 100 of rejection of authentication.

As described above, according to the present exemplary embodiment, the I/F unit 301 includes the rewriting permission table 1401 to permit or reject rewriting of a program memory when power supply from USB bus power is used, so that permission/rejection of rewriting is determined based on the rewriting permission table. This reduces the risk of failure in rewriting of memory.

In the present exemplary embodiment, the rewriting permission table is applied to the first exemplary embodiment, but obviously can be applied to the second to fourth exemplary embodiments.

In the first to fifth exemplary embodiments, program memories that store programs are described, but it is apparent that data is also applicable as well as programs.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-186189 filed Aug. 23, 2010, which is hereby incorporated by reference herein in its entirety.

What is claimed is:

1. An apparatus, comprising:
a storage unit;
a power source unit configured to supply power in a normal operation mode;
a power supply unit configured to receive power from an external apparatus;
a communication unit configured to communicate with the external apparatus;
a control unit configured to rewrite the storage unit using data received from the communication unit; and
a switching unit configured to switch power supply to the storage unit between from the power source unit and from the power supply unit,
wherein the control unit controls the switching unit, when receiving a rewrite request command from the external apparatus, to supply power to the storage unit from the power supply unit, so that rewriting of the storage unit is executed.

2. The apparatus according to claim 1, further comprising another storage unit,
wherein the switching unit switches power source to each of the storage units individually, and
wherein, when rewriting of a plurality of storage units is executed, the control unit controls the switching unit so that power is supplied from the power supply unit to a target storage unit for rewriting and then rewriting of the target storage unit is executed, and subsequently, after the target storage unit is separated from the power supply unit, power is supplied from the power supply unit to a next target storage unit for rewriting to serially change storage units for rewriting.

3. The apparatus according to claim 1, further comprising:
a connecting unit configured to connect units in the apparatus to one another; and
a bus switching unit configured to separate the storage unit and the control unit from the connecting unit,
wherein, when rewriting of the storage unit is executed using power supplied to the storage unit from the power supply unit, the control unit controls the bus switching unit so that the storage unit and the control unit are separated from the connecting unit and the power from the power supply unit is supplied only to the storage unit and the control unit.

4. The apparatus according to claim 1, wherein the control unit, when the switching unit is controlled to supply power from the power supply unit to the storage unit, performs a test on the storage unit, so that rewriting of the storage unit is executed when a result of the test indicates no error.

5. The apparatus according to claim 1, wherein rewriting permission information, which indicates whether rewriting of the storage unit is executed by power supplied from the power supply unit, is stored in the apparatus, and
wherein the control unit determines whether to execute rewriting of the storage unit based on the rewriting permission information, and when the control unit determines that the rewriting is executable, the rewriting of the storage unit is executed.

6. The apparatus according to claim 1, wherein, when the apparatus is connected to the external apparatus by a USB cable, the power supply unit receives power from the external apparatus through USB bus power.

7. The apparatus according to claim 1, further comprising an authentication unit configured to perform authentication of the storage unit with the external apparatus,
wherein, when the apparatus includes a plurality of storage units, the authentication unit performs authentication of each of the storage units individually.

8. The apparatus according to claim 1, wherein, when the storage unit receives power supplied from the power source unit, the control unit controls the switching unit to supply power from the power supply unit to the storage unit, so that rewriting of the storage unit is not executed.

9. A method of controlling an apparatus including at least one storage unit, a power source unit configured to supply power in a normal operation mode, a power supply unit configured to receive power from an external apparatus, a communication unit configured to communicate with the external apparatus, a control unit configured to rewrite the storage unit using data received from the communication unit, and a switching unit configured to switch power supply to the storage unit between from the power source unit and from the power supply unit, the method comprising:
receiving a rewrite request command from the external apparatus;
controlling the switching unit to supply power from the power supply unit to the storage unit, in response to the reception of the rewrite request command; and
rewriting the storage unit, by the control unit, based on data received through the communication unit.

10. The method according to claim 9, further comprising:
switching power supply to each of a plurality of storage units individually; and
controlling, when rewriting of the plurality of storage units is executed, the switching so that power is supplied from the power supply unit to a target storage unit for rewriting and then executing rewriting of the target storage, and subsequently, after the target storage unit is separated from the power supply unit, supplying power from the power supply unit to a next target storage unit for rewriting to serially change storage units for rewriting.

11. The method according to claim 9, further comprising:
connecting units in the apparatus to one another;
separating the storage unit and the control unit from the connecting unit; and
controlling the switching so that the storage unit and the control unit are separated and supplying the power from the power supply unit only to the storage unit and the control unit when rewriting of the storage unit is executed using power supplied to the storage unit from the power supply unit.

12. The method according to claim 9, further comprising performing a test on the storage unit, so that rewriting of the storage unit is executed when a result of the test indicates no error when the switching unit is controlled to supply power from the power supply unit to the storage unit.

13. The method according to claim 9, further comprising receiving power from the external apparatus through USB bus power when the apparatus is connected to the external apparatus by a USB cable.

14. The method according to claim 9, further comprising:
performing authentication of the storage unit with the external apparatus; and
performing authentication of each of the storage units individually when the apparatus includes a plurality of storage units.

15. The method according to claim 9, further comprising controlling the switching unit to supply power from the power supply unit to the storage unit, so that rewriting of the storage unit is not executed wherein, when the storage unit receives power supplied from the power source unit.

16. A storage medium storing a program that causes an apparatus to execute a method of controlling the apparatus including a storage unit, a power source unit configured to supply power in a normal operation mode, a power supply unit configured to receive power from an external apparatus, a communication unit configured to communicate with the external apparatus, a control unit configured to rewrite the storage unit using data received from the communication unit, and a switching unit configured to switch power supply to the storage unit between from the power source unit and from the power supply unit, the method comprising:
receiving a rewrite request command from the external apparatus;
controlling the switching unit to supply power from the power supply unit to the storage unit, in response to the reception of the rewrite request command; and
rewriting data stored in the storage unit based on data received from the external apparatus through the communication unit.

17. The storage medium according to claim 16, further comprising:
connecting units in the apparatus to one another;
separating the storage unit and the control unit from the connecting unit; and
controlling the switching so that the storage unit and the control unit are separated and supplying the power from the power supply unit only to the storage unit and the control unit when rewriting of the storage unit is executed using power supplied to the storage unit from the power supply unit.

18. The storage medium according to claim 16, further comprising performing a test on the storage unit, so that rewriting of the storage unit is executed when a result of the test indicates no error when the switching unit is controlled to supply power from the power supply unit to the storage unit.

19. The storage medium according to claim 16, further comprising:
performing authentication of the storage unit with the external apparatus; and
performing authentication of each of the storage units individually when the apparatus includes a plurality of storage units.

20. The storage medium according to claim 16, further comprising controlling the switching unit to supply power from the power supply unit to the storage unit, so that rewriting of the storage unit is not executed wherein, when the storage unit receives power supplied from the power source unit.
